(19) United States
(12) Patent Application Publication
(10) Pub. No.: US 2006/0044952 A1
(43) Pub. Date: Mar. 2, 2006

(54) Multiple path illumination for image display systems

(75) Inventors: Steven M. Penn, Plano, TX (US); Michael T. Davis, Richardson, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 10/926,817

(22) Filed: Aug. 26, 2004

(51) Int. Cl. G11B 21/08

(52) U.S. Cl. 369/30.01

(57) ABSTRACT

In one embodiment, a method for transmitting sources of light in an image display system includes generating a first plurality of light beams at a first light source. The first plurality of light beams are transmitted at a first illumination angle. A second plurality of light beams are generated at a second light source. The second plurality of light beams transmitted at a second illumination angle. The transmission of the first and second pluralities of light beams are oscillated from the first and second light sources such that each of the first and second light sources alternate between an active state and an inactive state.

### TECHNICAL FIELD OF THE INVENTION

This invention relates in general to image display systems, and more particularly to optical systems implementing micro-mirror based projection display systems.

### OVERVIEW

Spatial light modulators used in projection display systems are capable of projecting image details from media sources such as HDTV, DVD, and DVI. Conventional spatial light modulators are limited by their etendue, which dictates the energy available to the system. Specifically, the amount of light within a particular wavelength range that may be accepted by the spatial light modulator is limited by the etendue of the system. Light originating from light sources emitting narrow bands of light are typically not powerful enough to enable the light modulators to generate a correctly colored or sufficiently bright image. Further, light sources may fail when operated at increased temperatures and current levels.

### SUMMARY OF EXAMPLE EMBODIMENTS

In one embodiment, a method for transmitting sources of light in an image display system includes generating a first plurality of light beams at a first light source. The first plurality of light beams transmitted at a first illumination angle. A second plurality of light beams are generated at a second light source. The second plurality of light beams transmitted at a second illumination angle. The transmission of the first and second pluralities of light beams are oscillated from the first and second light sources such that each of the first and second light sources alternate between an active state and an inactive state.

Depending on the specific features implemented, particular embodiments of the present invention may exhibit some, none, or all of the following technical advantages. Various embodiments may be capable of oscillating light beams between multiple light sources. Accordingly, some embodiments may be capable alternating the multiple light sources between active and inactive states, and the duty factor of each light source may be reduced. Other embodiments may be capable of allowing a light source to cool while in an inactive state. Thus, the light sources may be operated at higher pulsed currents and lower junction temperature, and the life span of each light source 12 may be increased.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of the present invention, and for further features and advantages thereof, reference is now made to the following description taken in conjunction with the accompanying drawings, in which:

FIG. 1 is a block diagram of one embodiment of a portion of a projection display system implementing multiple light sources;

FIG. 2 is a block diagram of one embodiment of a light source;

FIG. 3 is a block diagram of an alternative embodiment of a light sources;

FIG. 4 is a graph illustrating a configuration of light emitting diodes and filters for an exemplary light source; and

FIG. 5 is a flow chart of a method of projecting light from multiple light sources.

### DETAILED DESCRIPTION OF EXAMPLE EMBODIMENTS

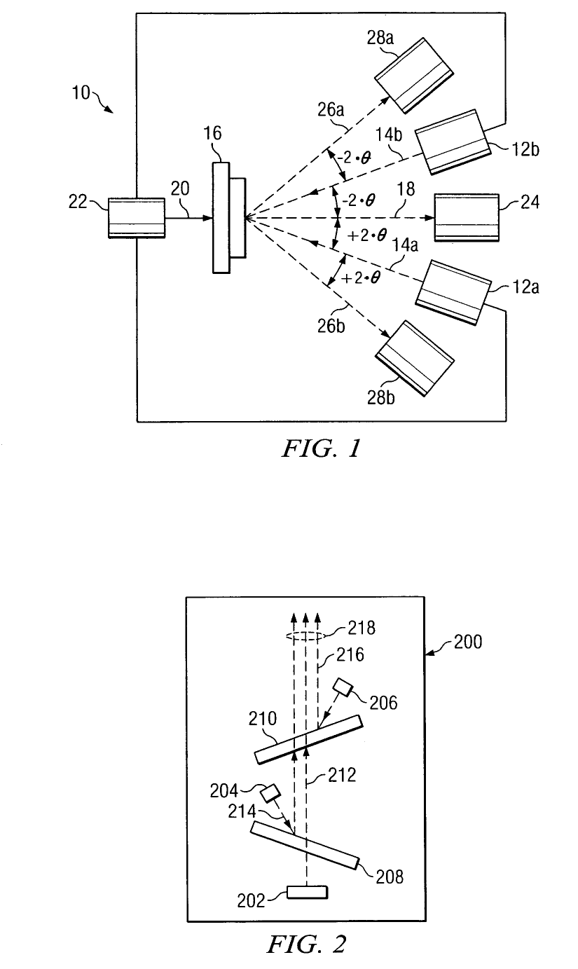

FIG. 1 is a block diagram of one embodiment of a portion of a projection display system 10 implementing multiple light sources 12. In this example, projection display system 10 includes a first light source 12a and a second light source 12b. First and second light sources 12a and 12b are capable of generating illumination light beams 14a and 14b, respectively, which are directed at a modulator 16. Modulator 16 may comprise any device capable of selectively communicating at least some of the received light beams along a projection light path 18. In various embodiments, modulator 16 may comprise a spatial light modulator, such as, for example, a liquid crystal display or a light emitting diode modulator.

In this particular embodiment, modulator 16 comprises a digital micro-mirror device (DMD). The DMD is a micro electromechanical device comprising an array of hundreds of thousands of tilting micro-mirrors. In a flat state, each micro-mirror may be substantially parallel to projection lens 24. From the flat state, the micro-mirrors may be tilted, for example, to a positive or negative angle to alternate the micro-mirrors between an “on” state and an “off” state. For discussion purposes, the angle at which the mirrors may tilt will be measured from projection path 18 and may be designated as theta. In particular embodiments, the micro-mirrors may tilt from a +10 degrees to a −10 degrees. In other embodiments, micro-mirrors may tilt from a +12 degrees to a −12 degrees. To permit the micro-mirrors to tilt, each micro-mirror attaches to one or more hinges mounted on support posts, and spaced by means of an air gap over underlying control circuitry. The control circuitry provides electrostatic forces, based at least in part on image data 20 received from a control module 22. In various embodiments, modulator 16 is capable of generating various levels or shades for each color received.

The electrostatic forces cause each micro-mirror to selectively tilt. Incident illumination light on the micro-mirror array is reflected by the “on” micro-mirrors along projection path 18 for receipt by projection lens 24. Additionally, illumination light beams 14a and 14b are reflected by the “off” micro-mirrors and directed on off-state light paths 26a and 26b, respectively, toward light dumps 28a and 28b, respectively. The pattern of “on” versus “off” mirrors (e.g., light and dark mirrors) forms an image that is projected by projection lens 24. As used in this document, the terms “micro-mirrors” and “pixels” are used inter-changeably.

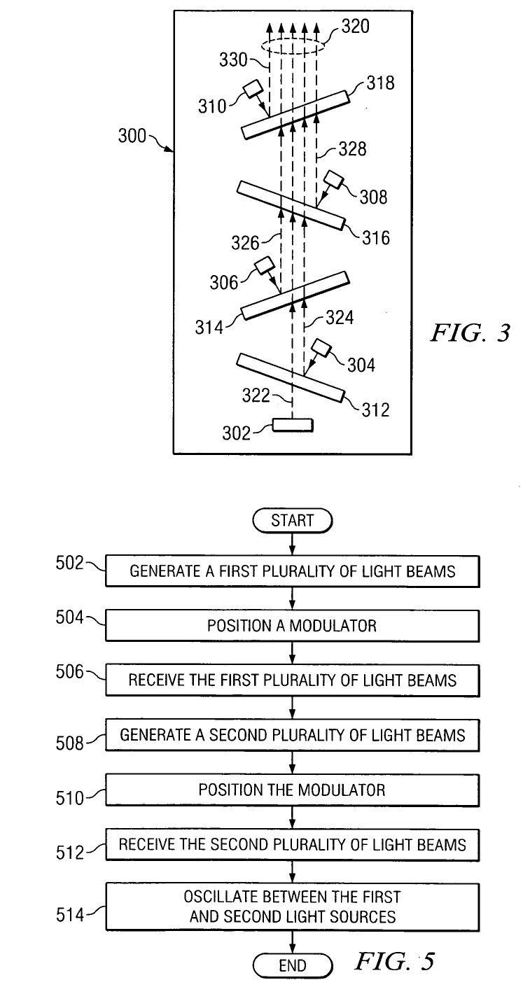

Light sources 12a and 12b may comprise any light sources, such as, for example, metal halide light sources, xenon arc light sources, ultra-high-pressure (UHP) mercury vapor arc lamps, or other broad-band light sources. In particular embodiments, each light source 12a and 12b may comprise an array of Light Emitting Diodes (LEDs), which generate narrow-band light. Unlike broad-band light which must be filtered using a color wheel to separate the light into its red, green, and blue components, an array of LEDs may be used to generate “field sequential” images of red, blue, and green components. The differently colored images may be perceived by a viewer through projection lens 24 as a correctly colored image. LEDs are described in more detail below with regard to FIGS. 2 and 3.

Where modulator 16 includes a plurality of tilting micro-mirror devices, a tilt on the order of approximately +10 to +12 degrees will result in first light source 12a being in an “on” state. Conversely, a tilt on the order of approximately −10 to −12 degrees will result in first light source 12a being in an “off” state. Although display system 10 is described and illustrated as including first and second light sources 12a and 12b, it is generally recognized that display system 10 may include any suitable number of light sources appropriate for generating light beams for transmission to modulator 16.

In particular embodiments, first light source 12a is positioned such that light beam 14a is directed at modulator 16 at an illumination angle of twice theta (where theta is equal to the degree of tilt of the micro-mirror devices in the “on” state). For example, where the micro-mirror devices tilt from approximately +10 to +12 degrees (“on”) to approximately −10 to −12 degrees (“off”), light beam 14a may be directed at modulator 16 from light source 12a positioned at an angle of approximately +20 to +24 degrees from projection path 18. Accordingly, light beam 14a may strike modulator 16 at an angle of approximately +20 to +24 degrees relative to the normal of the micro-mirrors when the micro-mirrors are in a flat state or an untilted position.

When the micro-mirror elements of modulator 16 are in the “on” state direction, illumination beam 14a is reflected approximately normal to the surface of projection lens 24 along illumination path 18. When the micro-mirror elements of modulator 16 are tilted in the “off” state direction, illumination light beam 14a from light source 14a is reflected along off state light path 26a where it is received by light dump 28a. Off state light path 26a is at a negative angle that is approximately equal to four times theta. Thus, where the micro-mirror devices are positioned at approximately −10 to −12 degrees when in the off state, light beam 14a is reflected at an angle of approximately −40 to −48 degrees, respectively, as measured from projection path 18.

In the illustrated embodiment, second light source 12b is positioned such that second light source 12b is symmetrical to first light source 12a with respect to modulator 16, projection path 18, and projection lens 24. Accordingly, where modulator 16 includes a plurality of tilting micro-mirror devices, a tilt on the order of approximately −10 to −12 degrees results in second light source 12b being in an “on” state. Conversely, a tilt of approximately +10 to +12 degrees results in second light source 12b being in an “off” state.

Second light source 12b is positioned such that light beam 14b is directed at modulator 16 at an illumination angle of twice theta (where theta is equal to the degree of tilt of the micro-mirror devices in the “on” state). For example, where the micro-mirror devices tilt from approximately −10 to −12 degrees (“on”) to approximately +10 to +12 degrees (“off”), light beam 14b may be directed at modulator 16 at an angle of approximately −20 to −24 degrees, respectively, as measured from projection path 18. Accordingly, light beam 14b may strike modulator 16 at an angle of approximately −20 to −24 degrees, respectively, as relative to the normal of the micro-mirrors when the micro-mirrors are in a flat state or an untilted position.

Like illumination beam 14a, illumination beam 14b is reflected approximately normal to the surface of projection lens 24 along illumination path 18 when the micro-mirror elements of modulator 16 are in the “on” state direction. Conversely, when the micro-mirror elements of modulator 16 are tilted in the “off” state, or positive direction, illumination light beam 14b from light source 14b is reflected along off state light path 26b where it is received by light dump 28b. Off state light path 26b is at an angle that is approximately equal to four times theta. Thus, where the micro-mirror devices tilt on the order of approximately +10 to +12 degrees when in the off state, light beam 14b is reflected at an angle of approximately +40 to +48 degrees, respectively, as measured from projection path 18.

As discussed above, system 10 includes a control module 22 that receives and relays image data 20 to modulator 16 to effect the tilting of micro-mirrors in modulator 16. In various embodiments, control module 22 may also operate to detect the source of light beams 14a and 14b. Accordingly, control module 22 may relay image data 20 that identifies the appropriate tilt of the micro-mirrors of modulator 16 based at least in part on the source of received lights beams 14a and/or 14b. For example, control module 22 may send image data 20 to modulator 16 that indicates to modulator 16 that at a given time a particular light beam 14a or a series of light beams 14a are being transmitted from first light source 12a. Thus, control module 22 may detect when first light source 12a is in an “active” state. When control module 16 detects that first light source 12a is “active,” control module 22 may direct the micro-mirrors of modulator 16 to tilt to the “on” state for reception of light beams 14a from first light source 12a. In particular example embodiments, control module 22 may direct the micro-mirrors of modulator 16 to tilt approximately +10 to +12 degrees to receive light beams 14a from first light source 12a.

Similarly, control module 22 may detect when first light source 12a becomes “inactive.” First light source 12a may be said to be inactive when first light source 12a stops transmitting light beams 14a. Modulator 16 may then begin receiving light beams 14 transmitted from another light source in display system 10. For example, control module 22 may direct the micro-mirrors of modulator 16 to tilt to the “on” state for reception of light beams 14b from second light source 12b. In particular example embodiments, control module 22 may direct the micro-mirrors of modulator 16 to tilt approximately −10 to −12 degrees to receive light beams 14b from second light source 12b. In this manner, control module 22 may detect when first light source 12a becomes “inactive” and second light source 12b becomes “active” and vice versa.

In various embodiments, control module 22 or another controller within display system 10 may also operate to control the transmission of light beams 14a and 14b from first and second light sources 12a and 12b, respectively. Accordingly, control module 22 may determine when first light source 12a and second light course 12b are in active or inactive states. Additionally, control module 22 may control the oscillation of light beams 14a and 14b from first and second light sources 12a and 12b, respectively, at a particular cycle rate. The alternating illumination may be timed on a low-frequency, frame-by-frame basis or on a high frequency, bit-by-bit basis. For example, control module 22 may oscillate the transmission of light beams 14a and 14b from first and second light sources 12a and 12b, respectively, between every frame. Thus, where a frame is 60 Hz, control module 22 may oscillate between light beams 14a and 14b at 60 Hz intervals. Alternatively, control module 22 may oscillate between light beams 14a and 14b within a single frame. Accordingly, control module 22 may oscillate between light beams 14a and 14b at 120 Hz intervals.

Oscillating the transmission of light beams 14a and 14b allows each light source 12a and 12b to alternate between active and inactive states. When first light source 12a is “active,” second light source 12b may be “inactive.” Conversely, when second light source 12a is “active,” first light source 12b may be “inactive.” The inactive state reduces the duty factor associated with each light source 12a and 12b. Additionally, the inactive state may allow each light source 12 to cool while the other light source 12 is active. As a result, first and second light sources 12a and 12b may be operated at higher pulsed currents and lower junction temperatures. For example, first and second light sources 12a and 12b may be operated at a pulsed current on the order of a few milliamps to a few amps, depending on the source capability. Further, because each light source 12 in display system 10 shares the duty of illuminating modulator 16, the life span of each light source 12 may be increased.

The energy available to display system 10 is defined by the etendue of modulator 16. The etendue dictates the optical invariant, which is the LED area multiplied by the solid angle of the light, available to light sources 12. Etendue can be defined by a product of the active area of modulator 16 with the sine-squared of the acceptance cone angle of modulator 16. For example, if modulator 16 has an active area of 100 mm² and an angle of acceptance of +24 degrees, the etendue of display system 10 is approximately 16.5 mm² steradians. The etendue of display system 10 is fixed by modulator 16. Only those wavelengths of light emitted from a particular source 12 within the etendue of display system 10 along the optical path are received at modulator 16.

FIG. 2 is a block diagram of one embodiment of a light source 200. Light source 200 includes an array of light emitters 202-206 separated by filters 208-210. In particular embodiments, light emitters 202-206 may comprise light emitting diodes (LEDs) that are configured to emit beams of narrow-band light of different colors. Although light emitters 202-206 will be described herein as including Light Emitting Diodes (LEDs), it is recognized that light emitters 202-206 may comprise any other light source suitable for emitting beams of broad-band or narrow-band light. Furthermore, although each light emitter 202-206 may be described as emitting beams of light within a defined range of wavelengths to produce desired bands of colors, some or all of light emitters 202-210 may be configured to emit beams of light within overlapping ranges of wavelengths of white light.

As illustrated, light source 200 includes a first LED 202, a second LED 204, and a third LED 206. First LED 202 and second LED 204 are separated by a first filter 208. Second LED 204 and third LED 206 are separated by a second filter 210. Each LED 202-206 operates to emit “field sequential” beams of light in wavelengths of desired colors. The differently colored beams of light emitted from each LED 202-206 are filtered such that the individual beams may be combined in an optical path 218 of display system 10. The combined light is then transmitted to modulator 16 and projection lens 24 as a correctly colored image.

In various embodiments, first LED 202 may be selected to emit first light beam 212. First light beam 212 may include light selected within a desired wavelength range. For example, first LED 202 may emit light beams 212 of a wavelength on the order of 400-475 nanometers. Thus, in this example, first LED 202 may emit blue light. Accordingly, first filter 208 may selectively pass blue light in a wavelength range on the order of 375-475 nanometers. Any light of a wavelength higher than 475 nanometers would be reflected by first filter 208 and may not be allowed to pass into optical path 218.

Second LED 204 may be selected to emit second light beam 214 in a wavelength range that is different from that of first LED 202. For example, second light beam 214 may include light selected within a desired wavelength range on the order of 485-570 nanometers. Thus, in this example, second LED 204 may emit green light. Second light beam 214 may be directed at first filter 208. Where first filter 208 is selected to pass only blue light, however, a second light beam 214 comprising green light may be reflected by first filter 208 and directed toward a second filter 210. In this manner, second light beam 214 is added to optical path 218. Accordingly, in this example, second filter 210 may be selected to pass blue and green light in a wavelength range on the order of 375-570 nanometers. Any light of a wavelength higher than 570 nanometers may be reflected by second filter 210 and, thus, not allowed to pass into optical path 218.

Third LED 206 may be selected to emit third light beam 216 in a wavelength range that is different from that of first and second LEDs 202 and 204. For example, third light beam 216 may include light selected within a desired wavelength range on the order of 610-690 nanometers. Thus, in this example, third LED 206 may emit red light. Third light beam 216 may be directed at second filter 210. Where second filter 210 is selected to pass only blue and green light, however, third light beam 216 comprising red light may be reflected by second filter 210. In this manner, third light beam 216 may be added to optical path 218.

In the example embodiment described above, the light beams added to optical path 218 are associated with successively increasing wavelengths. Accordingly, the filters are arranged in the order of highest pass frequency (blue) to lowest pass frequency (red). Thus, first filter 208 is configured to pass blue light beams 212 and reflect all others. Second filter 210 is configured to pass green light beams 214 and blue light beams 212 and reflect all others. It is recognized, however, that filters 208-210 may not actually reflect all light or pass light at the specified wavelengths. Rather, the cut-off for each filter 208-210 may be more accurately represented by a slope. Accordingly, the above description which includes filters 208-210 as reflecting all light at 475 and 570, respectively, merely represents an example situation for ideal filters. It is recognized, however, that light emitters 202-206 need not be arranged so that light beams 212-216 are added to optical path 218 in successively increasing wavelengths. Accordingly, filters 208-210 also need not be arranged in the order of highest pass frequency (blue) to lowest pass frequency (red). For example, light emitters 202-206 may be arranged in order successively decreasing wavelengths. Filters 208-210 would then be designed to pass and reflect the appropriate wavelengths of light taking into account the ordering of light emitters 202-206. Where light emitters 202-206 are not ordered from highest frequency to lowest frequency, or vice versa, however, a more complicated design of filters 208 and 210 may be required.

The number of LEDs 202-206 and the selection of colors are merely exemplary. Any number of LEDs 202-206 may be selected to emit appropriate beams of light of any desired wavelength range suitable for image display system 10. Thus, LEDs may be selectively designed to emit beams of primary colors, beams of secondary colors, or beams of white light. Additionally, it is generally recognized that first light source 12a and second light source 12b need not be designed the same. The LEDs 202-206 included in each light source 12 in image display system 10 may be chosen to selectively emit any appropriate color or range of colors. Accordingly, light sources 12a and 12b may include any suitable number of LEDs selected to generate any combination of colors.

In particular embodiments, a first light source 12a may include multiple LEDs emitting red, blue, and green, and second light source 12b may include a single LED emitting white light. In other embodiments, one of either of the first or second light sources 12a and 12b may include an LED emitting white light in combination with other LEDs emitting beams of red, blue, green, or another primary or secondary color. The addition of white light from second light source 12b may operate to provide full-white lumens.

In other embodiments, light source 12a may include a green and a blue LED, separated by an appropriately selected filter, while light source 12b may include a green and a red LED, also separated by an appropriately selected filter. In other embodiments, light source 12a may include green, blue, and red LEDs, separated by appropriately selected filters, and light source 12b may include a single LED that emits green beams. Because the human eye photopically requires more light within particular wavelength ranges to generate a correctly colored image, both the first and second light sources 12a and 12b may include an LED configured to emit green light in particular embodiments.

As described above with regard to FIG. 1, light sources within image display system 10 communicate with control module 22 or another controller. In various embodiments, control module 22 may operate to control the transmission of light beams 212-216 from LEDs 202-206, respectively. In operation, control module 22 may determine when it is appropriate for each LED 202-206 to emit light. Accordingly, in addition to controlling the oscillation of light between multiple light sources 12 within image display system 10, control module 22 may also control the cycle and rate of light beams 212-216 within each light source 200. The alternation of illumination between LEDs 202-206 may be timed on a high frequency, bit-by-bit basis. For example, control module 22 may alternate the operation of LEDs 202-206 to result in light beams 212-216 being emitted at intervals suitable for generating a desired image to be displayed by image display system 10. In particular embodiments, control module 22 may alternate the emission of light beams 212-216 from LEDs 202-206, respectively, within a single frame. Accordingly, each LED 202-206 within a light source 200 may be used during some portion of a 60 Hz frame to display the appropriate colors to modulator 16. Because LEDs may be operated at extremely fast rates, light beams 212-216 may be alternated at nanosecond intervals.

The high-speed alternation of light beams 14a within each light source 200 in image display system 10 allows image display system 10 to handle complex image sequences. Additionally, because light sources 200 are alternated between active and inactive states, light sources 200 may be operated at high current levels. Accordingly, a brighter image may be produced. Further, the separation of colors within each image may be less discernible to the human eye.

FIG. 3 is a block diagram of an alternative embodiment of a light source 300. Light source 300 includes an array of light emitters 302-310 separated by filters 312-318. As illustrated, light source 300 includes one or more LEDs operable to emit light beams associated with a secondary color, as is discussed in U.S. application Ser. No. ______ filed concurrently with this patent application.

In particular embodiments, light emitters 302-310 may comprise Light Emitting Diodes (LEDs) configured to emit beams of narrow-band light of different colors. Although light emitters 302-310 will be described herein as including LEDs, it is recognized that light emitters 302-310 may comprise any other light source suitable for emitting beams of broad-band or narrow-band light. Furthermore, although each light emitter may be described as emitting beams of light within a defined range of wavelengths to produce desired bands of colors, some or all of light emitters 302-310 may be configured to emit beams of light within overlapping ranges of wavelengths or white light.

Typically, LEDs are configured to emit narrow-band beams of red, green, or blue light. The human eye, however, photopically requires more light within particular wavelength ranges to generate a correctly colored image. For example, more beams of green light may be required to produce a correctly colored image than may be accepted within the etendue of an image display system implementing an array of LEDs. Accordingly, a composite coordinate associated with the light generated by the LEDs may be desired to increase the intensity of light received within a particular wavelength range. The composite coordinate may be the result of two LEDs of different wavelengths operating concurrently when the modulator demands a field sequential color spectrum.

As illustrated, light source 300 includes a blue LED 302, a cyan LED 304, a green LED 306, an amber LED 308, and a red LED 310. Each LED 302-310 is separated from neighboring LEDs by filters 312-318 designed to pass specific ranges of wavelengths and reflect other ranges of wavelengths. For example, in particular embodiments, blue LED 302 may be selected to emit blue light beams 322 of a wavelength on the order of 435-465 nanometers. Blue light beams 322 may be filtered at first filter 312 and introduced into optical path 320. Specifically, first filter 312 may be configured to pass blue light beams 322 and to reflect light beams of wavelengths outside this range. Accordingly, light of a wavelength higher than 470 nanometers may be reflected by first filter 312 and, thus, not allowed to pass into optical path 320. In particular embodiments, first filter 312 may be positioned such that it is tilted at an angle relative to optical path 320. For example, first filter 312 may be positioned such that first filter 312 is at an angle on the order of a +15 to +25 degrees, as measured from optical path 320. In particular embodiments, first filter 312 may be positioned at an angle on the order of +20 degrees. The orientation of first filter 312 may operate to minimize the angle of incidence (AOI) while maximizing the effectiveness and producibility of first filter 312. Although a lesser angle may be better for the design and efficiency of filter 312, mechanical packaging may influence the angle to avoid the interference of optical or mounting hardware with the generated light.

In particular embodiments, cyan LED 304 may be selected to emit cyan light beams 324 of a wavelength on the order of 470-520 nanometers. As illustrated, cyan LED 304 is positioned such that cyan beams 324 are directed at first filter 312. Where first filter 312 is configured to reflect any light of a wavelength higher than 470 nanometers, however, cyan beams 324 may be reflected from the surface of first filter 312. Accordingly, in various embodiments of light source 300, cyan beams 324 may be emitted from cyan LED 304 at an angle appropriate to result in the reflected cyan beams 324 being introduced into optical path 320. Cyan beams 324 and blue beams 322 may then be optically combined to travel concurrently in optical path 320 toward second filter 314.

Second filter 314 may operate to filter blue light beams 322 and cyan light beams 324. Specifically, second filter 314 may be configured to pass blue light beams 322 and cyan light beams 324. Additionally, second filter 314 may be configured to reflect light beams of wavelengths outside this range. Accordingly, light beams of a wavelength higher than 505 nanometers may be reflected by second filter 314 and, thus, not allowed to pass into optical path 320. In particular embodiments, second filter 314 may be positioned such that it is tilted at an angle relative to optical path 320. For example, second filter 314 may be positioned such that second filter 314 is at an angle on the order of a −15 to −25 degrees, as measured from optical path 320. In particular embodiments, second filter 314 may be positioned at an angle on the order of −20 degrees. The orientation of second filter 314 may operate to minimize AOI while maximizing the effectiveness and producibility of second filter 314.

In particular embodiments, green LED 306 may be selected to emit green light beams 326 of a wavelength on the order of 495-565 nanometers. As illustrated, green LED 306 is positioned such that green beams 326 are directed at second filter 314. Where second filter 314 is configured to reflect any light of a wavelength higher than 505 nanometers, however, green beams 326 may be reflected from the surface of second filter 314. Accordingly, in various embodiments of light source 300, green beams 326 may be emitted from green LED 306 at an angle appropriate to result in the reflected green beams 326 being introduced into optical path 320.

Third filter 316 may operate to filter blue light beams 322, cyan light beams 324, and green light beams 326. Specifically, third filter 316 may be configured to pass blue light beams 322, cyan light beams 324, and green light beams 326. Additionally, third filter 316 may be configured to reflect light beams of wavelengths outside this range. Accordingly, light of a wavelength higher than 590 nanometers may be reflected by third filter 316 and, thus, not allowed to pass into optical path 320. In particular embodiments, third filter 316 may be positioned such that it is tilted at an angle relative to optical path 320. For example, third filter 316 may be positioned such that, like first filter 312, third filter 316 is at an angle on the order of a +15 to +25 degrees, as measured from optical path 320. In particular embodiments, third filter 316 may be positioned at an angle on the order of +20 degrees. The orientation of third filter 314 may operate to minimize AOI while maximizing the effectiveness and producibility of third filter 316.

In particular embodiments, amber LED 308 may be selected to emit amber light beams 328 of a wavelength on the order of 580-610 nanometers. As illustrated, amber LED 308 is positioned such that amber beams 328 are directed at third filter 316. Where third filter 316 is configured to reflect any light of a wavelength higher than 590 nanometers, however, amber beams 328 may be reflected from the surface of third filter 316. Accordingly, in various embodiments of light source 300, amber beams 328 may be emitted from amber LED 308 at an angle appropriate to result in the reflected amber beams 328 being introduced into optical path 320.

Fourth filter 318 may operate to filter blue light beams 322, cyan light beams 324, green light beams 326, amber light beams 328. Specifically, fourth filter 318 may be configured to pass blue light beams 322, cyan light beams 324, green light beams 326, and amber light beams 328. Additionally, fourth filter 318 may be configured to reflect light beams of wavelengths outside this range. Accordingly, light of a wavelength higher than 620 nanometers may be reflected by fourth filter 318 and, thus, not allowed to pass into optical path 320. In particular embodiments, fourth filter 318 may be positioned such that it is tilted at an angle relative to optical path 320. For example, fourth filter 318 may be positioned such that, like second filter 314, fourth filter 318 is at an angle on the order of a −15 to −25 degrees, as measured from optical path 320. In particular embodiments, fourth filter 318 may be positioned at an angle on the order of −20 degrees. The orientation of fourth filter 318 may operate to minimize AOI while maximizing the effectiveness and producibility of fourth filter 318.

In particular embodiments, red LED 310 may be selected to emit red light beams 330 of a wavelength on the order of 615-645 nanometers. As illustrated, red LED 310 is positioned such that red beams 330 are directed at fourth filter 318. Where fourth filter 318 is configured to reflect any light of a wavelength higher than 620 nanometers, however, red beams 330 may be reflected from the surface of fourth filter 318. Accordingly, in various embodiments of light source 300, red beams 330 may be emitted from red LED 310 at an angle appropriate to result in the reflected red beams 330 being introduced into optical path 320. Red beams 330 and amber beams 328 may then be optically combined and travel concurrently in optical path 320 toward modulator 16.

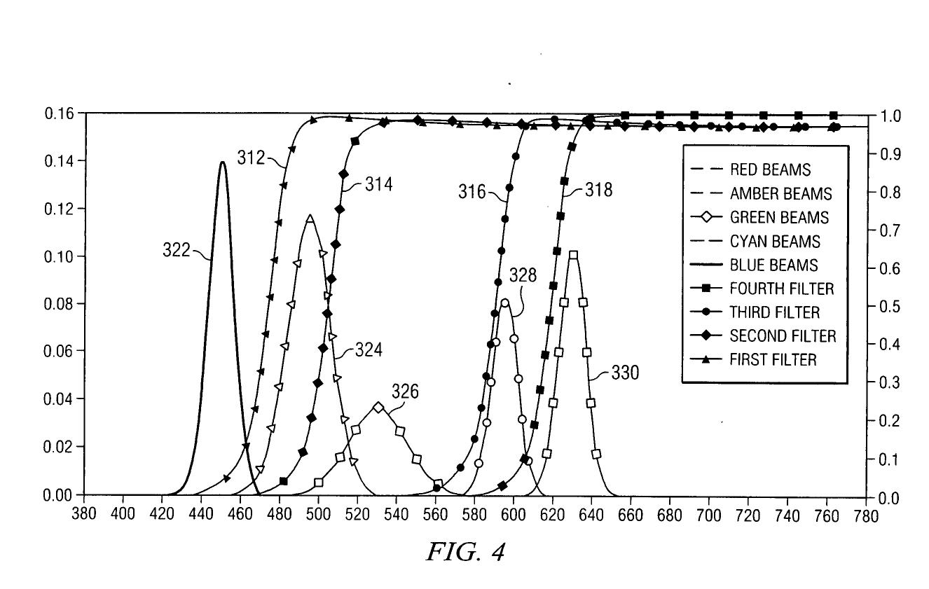

In the example embodiment described above, light beams 322-330 that are added to optical path 320 are associated with successively increasing wavelengths. Accordingly, the filters are arranged in the order of highest pass frequency (blue) to lowest pass frequency (red). Thus, first filter 312 is configured to pass blue light beams 322 and reflect all others. Similarly, second filter 314 is configured to pass blue light beams 322 and cyan light beams 324, while reflecting all others. Third filter 316 and fourth filter 318 are configured accordingly. The described configuration of LEDs and filters is illustrated in FIG. 4. FIG. 4 depicts the example wavelengths provided above as relating to LEDs 302-310. FIG. 4 also illustrates that filters 312-318 may not actually reflect all light or pass all light at the specified wavelengths. Rather, the cut-off for each filter 312-318 is represented by a slope. Accordingly, the above description which describes filters 312-318 as reflecting all light at 470, 505, 590, and 620 nanometers, respectively, merely presents an example situation for ideal filters. It is recognized, however, that LEDs 302-310 need not be arranged such that light beams 322-330 are added to optical path 320 in successively increasing wavelengths. Accordingly, filters 312-318 also need not be arranged in the order of highest pass frequency (blue) to lowest pass frequency (red). For example, LEDs 302-310 may be arranged in successively decreasing wavelengths or in any other appropriate order. Filters 312-318 would then be designed to pass and reflect the appropriate wavelengths of light taking into account the ordering of LEDs 302-310. In particular embodiments, it may be desirable to arrange the LEDs such that light beams from a green LED pass through the least number of filters since the brightness of the system may be limited by the green wavelengths. Where filters 312-318 are not ordered from highest pass frequency to lowest pass frequency, or vice versa, however, a more complicated design of filters 312-318 may be required.

The number of LEDs 302-310 and the selection of colors emitted by LEDs 302-310 are examples. Any number of LEDs 302-310 may be selected to emit appropriate beams of light in the desired wavelength ranges suitable for image display system 10. Because the human eye photopically requires more light within particular wavelength ranges to generate a correctly colored image, however, LEDs 302-310 and filters 312-318 may be selectively configured to create additional color channels that may be added to the existing color channels without exceeding the etendue limits of image display system 10. The combination of the additional colors with the standard colors offered by LEDs may result in a composite color coordinate associated with the LEDs. For example, amber LED 308 may be operated simultaneously with green LED 306 to shift the color coordinates associated with green LED 306 to an optimum setting. As another example, cyan LED 304 may be operated simultaneously with the blue LED 302 to result in a composite color coordinate at an optimum setting. As still another example, amber LED 308 may be operated simultaneously with red LED 310 to result in a composite color coordinate at an optimum setting. In this manner, the light output of the etendue limited color channels associated with blue or red may also be increased. Combining the LEDs as described allows more energy to be produced from the combined or composite wavelengths and summed optical area. The color channels may be allowed to operate at proportionally increased luminous flux levels.

FIG. 5 is a flow chart illustrating a method of projecting light from multiple light sources. At step 502, a first plurality of light beams 14a is generated. The first plurality of light beams 14a may be generated at a first light source 12a and may be transmitted at a first illumination angle. Because the first plurality of light beams 14a are generated by first light source 12a, first light source 12a may be said to be “active” during step 502.

In particular embodiments, first light source 12a includes a first array of light emitting diodes 202-206. The first array of light emitting diodes 202-206 may emit any combination of appropriately colored light beams. Control module 22 may operate to cycle the differently colored light beams such that the light beams are combined in optical path 218 for transmission to modulator 16 at the first illumination angle. In particular embodiments, the first illumination angle may be on the order of a +20 to a +24 degrees from projection path 18.

At step 504, modulator 16 is positioned to receive the first plurality of light beams 14a. As discussed above, modulator 16 may comprise an array of micro-mirror devices that may be tilted to receive the first plurality of light beams 14a in particular embodiments. Positioning the modulator 16 may include tilting all or a portion of the micro-mirror devices at a first tilt angle. The first tilt angle is generally a positive one-half of the first illumination angle. Stated differently, the first illumination angle is generally twice the first tilt angle. Accordingly, where the first plurality of beams 14a are transmitted at a first illumination angle between a +20 and a +24 degrees, the first tilt angle may be between a +10 and a +12 degrees, as measured from projection path 18. At step 506, the first plurality of light beams 14a are received at modulator 16. Upon being received by modulator 16, at least a portion of light beams 14a may be directed to projection lens 24 along projection path 18.

At step 508, a second plurality of light beams 14b are generated. The second plurality of light beams 14b may be generated at a second light source 12b and may be transmitted at a second illumination angle. In particular embodiments, the second illumination angle may be on the order of a −20 to a −24 degrees from projection path 18. Because the second plurality of light beams 14b are generated at second light source 12b, second light source 12b may be said to be “active” at step 508. Additionally, first light source 12b may be “inactive” during at least a portion of the time that second light source 12b is “active.”

Similar to first light source 12a, second light source 12b may also comprise an array of light emitting diodes 202-206. The array of light emitting diodes 202-206 may emit appropriately colored light beams which are cycled such that the light beams may be combined in optical path 218 for transmission to modulator 16 at a second illuminations angle. As described above, the second illumination angle may be on the order of a −20 to a −24 degrees from projection path 18. At step 510, modulator 16 is positioned to receive the second plurality of light beams 14b. In particular embodiments, control module 22 may operate to tilt one or more micro-mirrors of modulator 16 to a second tilt angle. The second tilt angle is generally a positive one-half of the second illumination angle. Accordingly, where the second illumination angle is on the order of a −20 to a −24 degrees, the micro-mirrors of modulator 16 may be tilted to an angle that is on the order of a −10 to a −12 degrees, as measured from projection path 18. At step 512, the second plurality of light beams 14b are received at modulator 16. Upon being received by modulator 16, at least a portion of light beams 14b may be directed to projection lens 24 along projection path 18.

At step 514, control module 22 may oscillate the transmission of light beams from multiple light sources 12. Thus, steps 502-512 may be continually repeated. In this manner, the transmission of light beams 14a and 14b from light sources 12a and 12b, respectively, may be said to be oscillated or alternated. The oscillation of light beams 14a and 14b allows each light source 12a and 12b to alternate between active and inactive states. As described above, first light source 12a may be “active” while second light source 12b is “inactive.” Conversely, second light source 12b may be “active” while first light source 12a is “inactive.” Accordingly, the duty factor of each light source may be reduced, and light sources 12 may be allowed to cool. As a further result, light sources 12 may be operated at higher pulsed currents and lower junction temperatures. Thus, a brighter image may be produced, and the separation of colors within each image may be less discernible to the human eye. Additionally, the life span of each light source 12 may be improved.

Although the present invention has been described in several embodiments, a myriad of changes, variations, alterations, transformations, and modifications may be suggested to one skilled in the art, and it is intended that the present invention encompass such changes, variations, alterations, transformations, and modifications as falling within the spirit and scope of the appended claims.

What is claimed is:

1. An image display system comprising:
a modulator comprising an array of micro-mirror devices, the modulator operable to receive a plurality of light beams, each of the plurality of light beams received by the modulator at an associated illumination angle;
a first light source operable to generate a first light beam for transmission to the modulator at a first illumination angle, the first light source comprising a first array of light emitting diodes, the micro-mirror devices of the modulator positioned at a first tilt angle to receive the first light beam transmitted at the first illumination angle;
a second light source operable to generate a second light beam for transmission to the modulator at a second illumination angle, the second light source comprising a second array of light emitting diodes, the micro-mirror devices of the modulator positioned at a second tilt angle to receive the second light beam transmitted at the second illumination angle; and
a control module operable to:
oscillate the transmission of light beams between the first and second light sources such that each of the first and second light sources alternate between an active state and an inactive state, the first light source in the inactive state when the second light source is in the active state, the second light source in the inactive state when the first light source is in the active state;
direct at least a portion of the first and second light beams along a projection path.

2. An image display system comprising:
a modulator operable to receive a plurality of light beams, each of the plurality of light beams received by the modulator at an associated illumination angle;
a first light source operable to generate a first light beam for transmission to the modulator at a first illumination angle;
a second light source operable to generate a second light beam for transmission to the modulator at a second illumination angle; and
a control module operable to oscillate the transmission of light beams between the first and second light sources such that each of the first and second light sources alternate between an active state and an inactive state.

3. The system of claim 2, wherein:
the first light source is in the inactive state when the second light source is in the active state; and
the second light source is in the inactive state when the first light source is in the active state.

4. The system of claim 2, wherein:
the first light source comprises a first array of light emitting diodes; and
the second light source comprises a second array of light emitting diodes.

5. The system of claim 4, wherein the first array of light emitting diodes comprise red, green, and blue emitting diodes.

6. The system of claim 5, wherein the second array of light emitting diodes comprises a green emitting diode.

7. The system of claim 5, wherein the second array of light emitting diodes comprise red, green, and blue emitting diodes.

8. The system of claim 5, wherein the second array of light emitting diodes comprises a white emitting diode.

9. The system of claim 2, wherein the modulator comprises an array of micro-mirror devices, the micro-mirror devices configured to be positioned at a first tilt angle to receive the first light beam transmitted at the first illumination angle and at a second tilt angle to receive the second light beam transmitted at the second illumination angle.

10. A method for transmitting sources of light in an image display system, comprising:
generating a first plurality of light beams at a first light source, the first plurality of light beams for transmission at a first illumination angle;
generating a second plurality of light beams at a second light source, the second plurality of light beams for transmission at a second illumination angle; and
oscillating the transmission of the first and second pluralities of light beams from the first and second light sources such that each of the first and second light sources alternate between an active state and an inactive state.

16. The method of claim 10, wherein:
the first light source is in the inactive state when the second light source is in the active state; and
the second light source is in the inactive state when the first light source is in the active state.

12. The method of claim 10, wherein:
the first light source comprises a first array of light emitting diodes; and
the second light source comprises a second array of light emitting diodes.

13. The method of claim 12, wherein generating the first plurality of light beams comprises generating a plurality of red, green, and blue light beams.

14. The method of claim 13, wherein generating the second plurality of light beams comprises generating a plurality of green light beams.

15. The method of claim 13, wherein generating the second plurality of light beams comprises generating a plurality of white light beams.

16. The method of claim 13, wherein generating the second plurality of light beams comprises generating a plurality of red, green, and blue light beams.

17. The method of claim 10, further comprising:
receiving the first and second pluralities of light beams at a modulator comprising an array of micro-mirror devices;
positioning the micro-mirror devices at a first tilt angle to receive the first plurality of light beams transmitted at the first illumination angle; and
positioning the micro-mirror devices at a second tilt angle to receive the second plurality of light beams transmitted at the second illumination angle.

18. A method for receiving sources of light in an image display system, comprising:
receiving a first plurality of light beams at a modulator, the first plurality of light beams received at a first illumination angle from a first light source;
receiving a second plurality of light beams at the modulator, the second plurality of light beams received at a second illumination angle from a second light source;
oscillating between the first and second light sources such that the first and second light sources each alternate between an inactive state and an active state, the first light source in the inactive state when the second light source is in the active state, the second light source in the inactive state when the first light source is in the active state.

19. The method of claim 18, wherein:
the first light source comprises a first array of light emitting diodes; and
the second light source comprises a second array of light emitting diodes.

20. The method of claim 18, wherein the modulator comprises an array of micro-mirror devices, the micro-mirror devices positioned at a first tilt angle to receive the first plurality of light beams transmitted at the first illumination angle, the micro-mirror devices positioned at a second tilt angle to receive the second plurality of light beams transmitted at the second illumination angle.
